(19) United States
(12) Patent Application Publication
(10) Pub. No.: US 2002/0014166 A1
(43) Pub. Date: Feb. 7, 2002

(54) Workpiece ejector for transfer press

(76) Inventor: Brian Hennah, Twickenham (GB)

Correspondence Address: Martin G. Linihan, Hodgson Russ LLP, Suite 2000, One M&T Plaza, Buffalo, NY, 14203-2391, US

(21) Appl. No.: 09/802,495

(22) Filed: Mar. 9, 2001

(30) Foreign Application Priority Data
Mar. 10, 2000 (GB) 0005885.9

(51) Int. Cl. B30B 15/32; F16H 25/08

(52) U.S. Cl. 100/218; 74/54

(57) ABSTRACT

A transfer press has a combined spring and cam-driven workpiece ejector. A spring-box 88 and a cam 32 act through a common element, namely a bell-crank 62. Either the cam or the spring-box may be removed, ejection then being provided by the other. The bell-crank is mounted on the front of the press and the cam is carried by a mounting 78 enabling it to be removed from the front of the press. Accessibility is improved compared to known presses.

This invention relates to a workpiece ejector for a press, particularly (but not exclusively) for a transfer press.

In a transfer press, a workpiece is converted from a blank (generally a sheet metal blank) to a formed component by passing it through a succession of stations typically twelve or more. Each station has a respective press-tool (usually called a punch) and die, and each performs on the workpiece an incremental drawing, piercing or cutting operation. After each operation the workpiece is removed from the die at the station and is transferred to the die of the next station, eg. by a transfer slide as described in our earlier specification no. EP 0207659A.

For the transfer operation to be effected reliably the workpiece must be removed from the die in a controlled manner . Often the workpiece tends to stick to the punch as it is withdrawn, and thus is removed from the die. It is subsequently freed from the punch by a stripping device, and must not fall back into the die after removal.

Conventionally, a transfer press is provided at each station with a workpiece ejector mechanism which comprises an ejector member or plunger which extends through a bore in the bottom of the die. When operated the plunger advances through the bore to dislodge or displace the workpiece, if it has not already been removed by the ascending punch, and to occupy the die cavity so that the workpiece can not fall back into it. References in this specification to ejection or displacement of a workpiece are intended to include both of or either of the physical displacement of the workpiece from the die, and the occupation of the die cavity to prevent the workpiece re-entering it.

There are two known types of workpiece ejector. One consists of a spring-loaded (biased) plunger which is fitted beneath the press platen (bed) in alignment with the die. Downward movement of the punch presses the workpiece fully into the die, compressing the spring. When the punch is withdrawn the spring advances the plunger and ejects the formed workpiece. The other type of ejector employs a cam carried by the lower cam shaft of the press, also located beneath the press platen, to eject the workpiece by advancing the plunger at an appropriate time in the press cycle.

This type of ejector is employed when a heavier or more positively controlled ejection of the workpiece is required.

The two types of ejector are alternatives, and each is chosen according to the nature of the workpiece and the operation performed at the particular station. Changing from one ejector type to the other requires a tool-setter or mechanic to work on the press beneath the press platen to remove the ejector mechanism and replace it with another. Gaining access to the lower pan of the press is difficult due to the machine guards which surround the working parts, and the ejector mechanisms themselves can be of considerable size and weight on a large press. Then the task of changing the ejector mechanism is physically onerous and can result in considerable down-time, especially if the tooling for the particular workpiece is under development and requires frequent changes or modifications,

The preferred embodiment of the invention is directed to providing a spring-biassed workpiece ejector which can be fitted to the press in a more accessible and less time-consuming manner. Alternatively or in addition, the preferred embodiment seeks to provide a workpiece ejector which can easily be adapted from spring-biassed operation to cam-driven operation, with an attendant reduction in the difficulty of the conversion task.

In one aspect the invention provides a workpiece ejector for a press comprising an ejector member for displacing a workpiece out of a die, the ejector being resiliently biased (eg. by a sprig) via a pivoting lever to effect said displacement, and a mounting supporting the lever and for attachment to a front face of the platen of the press or to other accessible structure of the press,

By “accessible structure” we mean a surface or mounting point which is at or adjacent a boundary of the space envelope occupied by the press body, so that access to it can be gained from beside rather than beneath the press platen. The front face of the press platen or the underside of the platen adjacent its front edge is a convenient such accessible structure. If another part of the press also presents such an accessible structure, it may be used instead. Sometimes, the rear face of the platen or other accessible structure at the rear of the press may be suitable.

Preferably the pivot axis of the lever is at or adjacent the edge of the platen.

The ejector may also comprise a cam drive for effecting said displacement, the resilient-biassing and the cam drive acting on the ejector member via the pivoted lever.

In another aspect the invention provides a workpiece ejector for a press comprising an ejector member for displacing a workpiece out of a die, the ejector member being resiliently-biased to effect the ejection, and further driveable from a cam of the press to effect said ejection, the spring-biasing and the cam drive acting on the ejector member via a common element,

The common element may act as a cam follower, and may be a pivoting lever.

The pivoting lever may be a bell-crank.

Preferably the resilient-biasing and/or the cam drive is/are capable of being selectively disabled.

The resilient-biasing may be provided by a removable cartridge including a spring and means for transmitting an actuating force therefrom, the resilient-biasing being disabled by removal of the cartridge.

The cam drive may include a cam mountable and demountable radially of a driving shaft of the press mounted, demounting of the cam disabling the cam drive.

The shaft may comprise a age to which the cam is configured to be releasably attached.

In another aspect the invention provides an arrangement for mounting a cam on a cam shaft comprising a cam carrier for fixing to the shaft, and a cam comprising an aperture permitting it to be placed on the shaft by movement radially thereof, and means for securing the cam to the cam carrier.

The carrier may have a flange which the securing means engages.

The flange may have an aperture into which the securing means enters during said radial movement of the cam.

The invention also provides a press comprising a workpiece ejector or cam mounting arrangement as set fort above.

The invention will now be described merely by way of example with reference to the accompanying drawings, wherein:

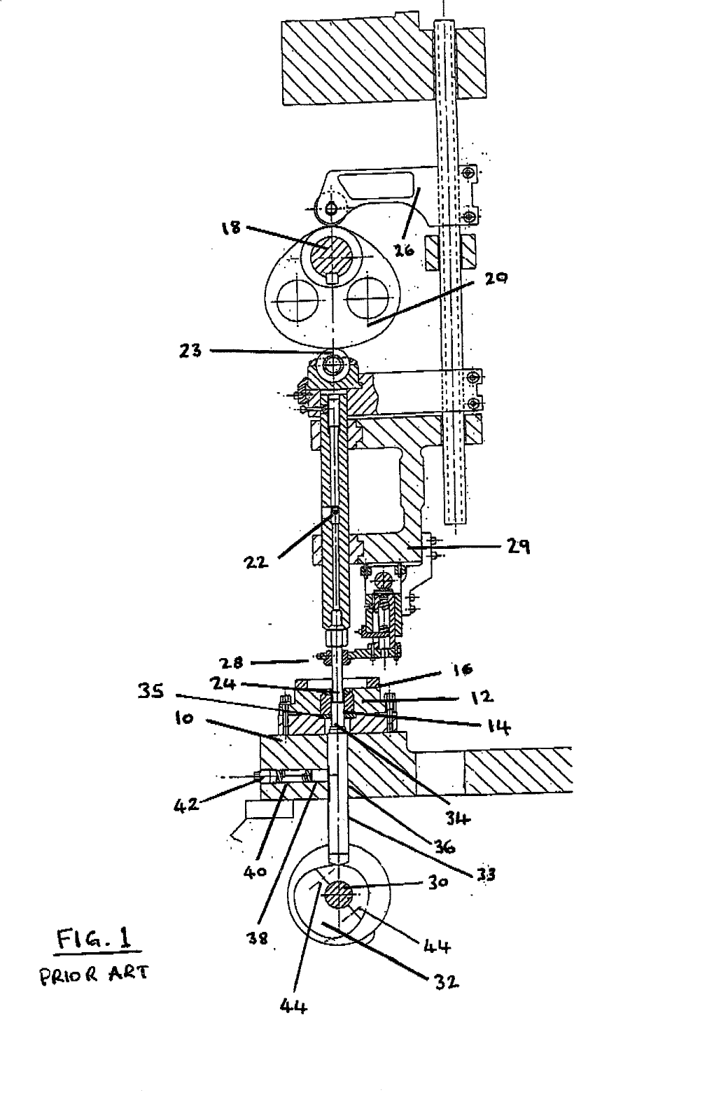

FIG. 1 is a vertical section through a station of a conventional transfer press, perpendicular to the longitudinal extent of the press-bed or platen, showing a cam-driven workpiece ejector.

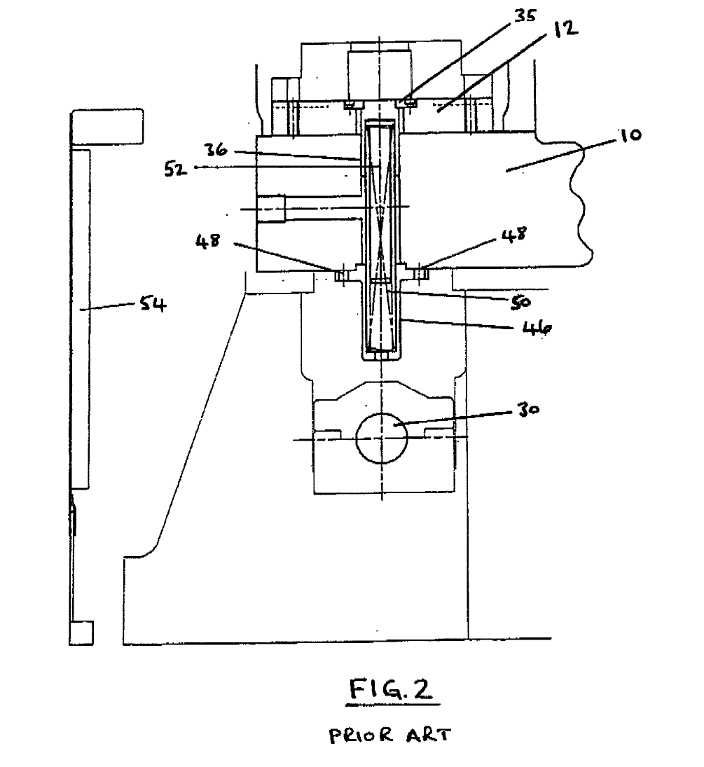

FIG. 2 is a like section through a detail of another conventional press, showing a resiliently-biassed (“spring-box”) ejector.

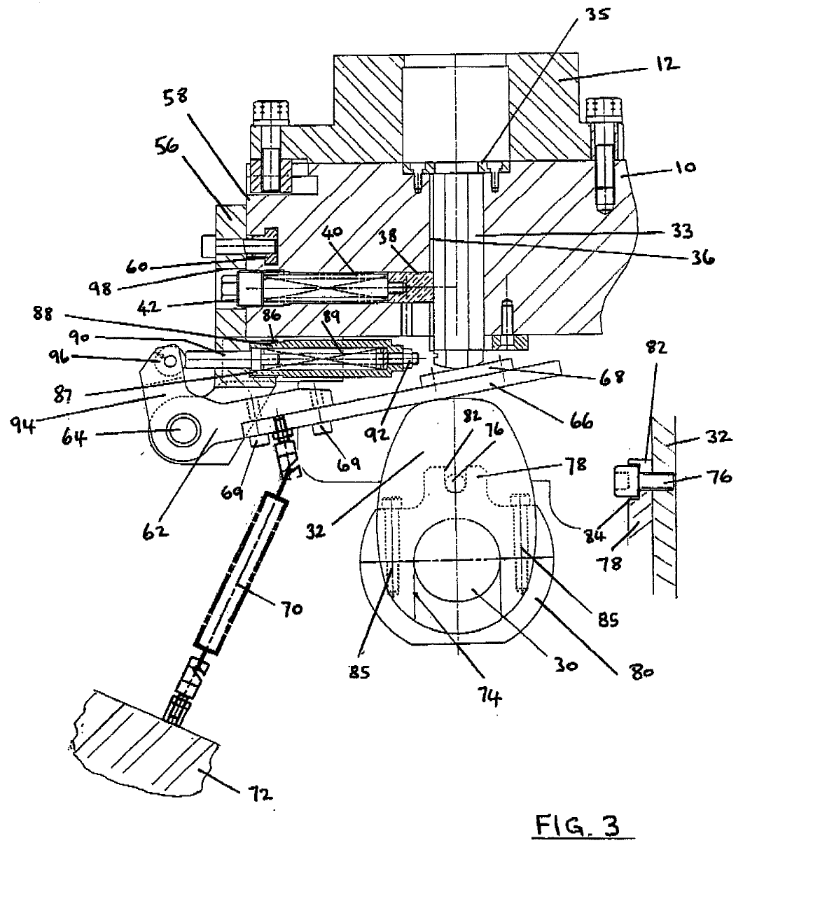

FIG. 3 shows a workpiece ejector according to the invention.

Referring to FIG. 1, and so far as relevant to the present invention, a conventional transfer press comprises a press-bed or platen 10 on which is mounted a die block 12 containing for each station a die 14. A reciprocating transfer slide 16 moves workpieces successively from one station to the next.

An upper cam shaft 18 has a cam 20 for each station, the cam operating a vertically moveable ram 22 via a cam follower 23. The ram carries at its lower end a punch 24. Downward movement of the ram cases the punch and die to effect a forming operation on a workpiece disposed in the die.

The ram is withdrawn upwards by a lining arm 26, which also is operated by the cam 20. A stripper 28, carried by fixed structure 29 and through which the punch passes, is provided to dislodge the workpiece from the punch, if it is retained on the punch when withdrawn from the die.

Beneath the platen 10 is a lower cam shaft 30 carrying, at each station at which the function is required, a cam 32 either for effecting forming operations on the workpiece from below or, as in this case, for operating a workpiece ejector member 33 which passes through an aperture in the bottom of the die 14. The ejector member passes through a bore 36 in the platen 10, in which it is a sliding fit, and has a separate or separable upper portion 34 which is part of the tooling for the particular pressing operation, and which is dimensioned according to the particular die and workpiece with which it is to be used, The portion 34 can be replaced from above the platen 10 by removing the die block 12. A replaceable ejector ring 35 is provided in the top surface of the platen 10, and is selected to suit the diameter of portion 34. It prevents over-travel of the portion 34 by engaging a shoulder thereon. A brake consisting of a friction pad 38 in a bore intersecting the bore 36 is pressed into frictional contact with the ejector member 34 by a spring 40. The spring is compressed by a screw 42. Moving the screw in or out adjusts the bring force. The brake prevents the ejector member retracting into the die 14 when the cam 32 has rotated and no longer supports it. Thereby it prevents the workpiece falling back into the die when it is stripped from the punch 24.

If it is required to replace the cam-driven ejector mechanism with the spring-loaded type, the cam 32 and ejector member 33 must be removed. Typically the cam is of split construction, in two pieces held together by socket screws 44, which must be withdrawn from beneath the press. Reassembly requires the two parts to be brought together round the shaft and the screws reinserted. The angular alignment of the cam must be carefully re-set each time it is replaced.

When the ejector mechanism 32, 33 has been removed, a spring-loaded type as shown in FIG. 2 can be substituted. The ejector of FIG. 2 is a spring-box or cartridge comprising a casing 46 bolted at 48 to the underside of the press platen 10 and extending into the bore 36 of the platen. A spring 50 within the casing 46 biasses a plunger or piston 52 upwardly against the ejector ring 35, When against the ring, the end of the plunger 52 is flush with the top of the platen 10 and via an end-piece (not shown, but equivalent to the part 34 of FIG. 1) which projects into the die, ejects the workpiece from the die, or prevents it falling back into the die.

A machine guard 54 is shown in FIG. 2 to illustrate the relative inaccessibility of the cam shaft 30 and the underside of the platen 10. All or part of the guard must be removed for access, if only part of the guard is removed, access is impeded by the remaining guard frame. This procedure is necessary both to replace the spring-box ejector with cam-driven ejector, or to change the spring force of the spring-box whether by adjustment or by substituting the spring. All of these tasks have to be performed beneath the press, and in particular changing the spring is not easy, since the spring must be compressed manually in order to fit it.

FIG. 3 shows a combined cam and spring-driven workpiece ejector according to the invention. Parts already described with reference to FIGS. 1 and 2 have the same reference numerals. A bracket 56 is fixed to the front face 58 of the press platen 10 by bolts engaging T-headed nuts 60 captive within a T-slot in the front face of the platen. The bracket carries a bell-crank lever 62 which is pivotally-mounted about an axle 64 proximate the front lower corner of the platen 10. One arm 66 of the bell-crank lever extends to form a follower for cam 32, and transmits the cam motion via slipper pad 68 to the Sector member 33, the top portion 34 of which is not shown in FIG. 3, but is provided as described in the context of FIG. 1. The cam 32, the arm 66 and the slipper pad 68 all are case-hardened to withstand wear, but over time wear will nevertheless occur. The slipper pad 68 therefore can be detached from the arm and replaced, either by an identical pad or by a pad of increased thickness if it is necessary to compensate for wear on the cam 32 or on the underside of the arm 66, or on the end of the ejector member 34. If necessary, the arm 66 can itself be replaced by releasing bolts 69. A light spring 70 anchored to fixed structure 72 of the machine holds the arm 66 in contact with the cam 32.

The cam 32 is modified compared to that of FIG. 1 by having a U-shaped slot dimensioned to fit closely over a saddle key 74 which is a integral part of a cam carrier 80. The cam 32 is secured to the carrier 80 by means of a socket headed bolt 76 to a flange 78 on carrier 80. The cam carrier 80 has a “U” shaped slot 82 into which the bolt 76 is received, and a recess 84 to accommodate the head of the bolt and positively locate the cam 32 on to the carrier 80. Thus the cam 32 can easily be removed from the shaft 30 by turning the shaft until the cam is facing forwardly (ie. at nine o'clock in FIG. 3), releasing the bolt 76 until the underside of its head clears the recess 84, and then withdrawing the cam from the shaft. Reassembly is equally simple, the angular orientation of the cam relative to the shaft being maintained by the carrier 80, which remains fixed on the shaft.

The carrier 80 is of split construction, being in two parts clamped around the shaft 30 by bolts 85. There is provided adjacent the carrier an angular scale keyed to the shaft axis which by means of a datum mark on the carrier, permits the carrier (and therefore the cam 32) to be correctly angularly set on the shaft. Once set, the carrier need not be disturbed. It will be appreciated that this method of mounting the cam 32 on the shaft can be used when the cam is employed to drive a lower punch rather than an ejector, and indeed is of more general application in presses having rotary cams.

The bracket 56 has a threaded socket 86 supporting a spring-box or cartridge 87 beneath the lower front edge of the platen 10. The spring-box comprises a casing 88 containing a compression spring 89, a plunger 90 retained by a stop and an adjusting screw 92. Advancing the screw into the casing compresses the spring and increases the pre-load on the plunger 90. The plunger 90 acts on the shorter arm 94 of the bell-crank lever 62 via a roller 96 carried by the bell-crank. Several ranges of adjustment can be provided by substituting springs 89 of different stiffnesses.

In use, if spring-biassed ejection of the workpiece is required, Be cam 32 is removed as already described, and the spring force provided by the spring cartridge 87 is communicated via the plunger 90 and the bell crank lever 62 to the ejector member 33. If cam-driven ejection is required the bracket 56 is removed from the front face of the platen 10, working from the front of the machine. The spring cartridge 87 is removed and the bracket 56 is re-fitted to the platen. An appropriate cam 32 then is fitted to drive the ejector member 33 via the arm 66 acting as a cam follower. By being mounted more or less on the boundary of the space envelope occupied by the press body, the bracket 56, lever 82 and cartridge 87 may easily be accessed from the front of the machine.

Thus the press can be converted from spring-biassed workpiece ejection to cam-driven ejection much more readily and conveniently than hitherto.

The advantages of the described embodiment compared to the separate spring-box or cam ejection units can be:

1. All ejector changeover is done from the front of the press and on the work-bench and not as previously underneath the press-bed with limited accessibility and in an oily environment. Down time and lost production are reduced.

2. Fitting different ejection springs to achieve different loadings involved unscrewing the spring box from underneath the press-bed, changing the spring and refitting, not an easy job against the spring pressure. In the preferred embodiment the bracket 56 can be released quickly and either the spring adjuster 92 is adjusted or a different spring 89 is fitted, Repositioning is equally quick.

3. Since the ejector cam 32 is not a split cam but simply slides onto the cam carrier 80 and is then fixed with a single very accessible bolt, cam fitting time is much reduced. Since the split cam carrier remains bolted to the shaft 30 the ejector cam 32 when refitted automatically maintains the same angular position.

4. Adjacent to the cam carrier 80 is a graduated indicator ring keyed to the bottom shaft. Upon releasing the cam carrier locking screws, the cam carrier can be adjusted and the angular position noted from the graduated indicator ring, reducing future tool fitting times.

5. With conventional spring or cam ejectors, different ejector rams are fitted for spring operation and cam operation, necessitating the replacement of the bed ejector rings 35 when changing from one system to another. The preferred embodiment uses a cordon ejector ram.

Although as described the spring ejection and cam-driven ejection can be selectively disabled, if desired both can be used at once. For example a low-lift cam 32 can be employed just to nudge the workpiece free of the die if it would not otherwise reliably separate from it. Then the spring force from the spring cartridge can takeover and propel the workpiece clear of the die.

The brake 38, 40 can be used or not, depending on the circumstances. The bracket 56 is apertured at 98 to permit access to the brake adjuster 42 to permit adjustment or indeed disabling of the brake by backing-off the adjuster.

In a possible alternative embodiment, the arm 66 of the bell-crank 62 is shorted and the pivot axis 64 is re-located beneath the press-platen 10, inwardly of its front face. The pivot axis mounting is provided either from the underside of the platen 10, or from an extension of bracket 56. The spring-box 87 is replaced by a tension spring extending between the arm 94 of the bell-crank 62 and the bottom of the bracket 56. Then the spring tension pulls the bell-crank anti-clockwise about its pivot axis 64, applying an ejecting force to the ejector member 33. The tension on the spring can be adjusted by providing a suitable adjusting screw red by the bracket 56, or alternatively the spring can be replaced by one of different stiffness, in both cases from the front of the press. Conversion to cam-driven ejection is achieved by removing the spring, or releasing its tension by backing-off the adjustment screw.

Each feature disclosed in this specification (which term includes the claims) and/or shown in the drawings may be incorporated in the invention independently of other disclosed and/or illustrated features.

Statements in this specification of the “objects of the invention” relate to preferred embodiments of the invention, but not necessarily to all embodiments of the invention falling within the claims.

The text of the abstract filed herewith is repeated here as part of the specification.

A transfer press has a combined spring and cam-driven workpiece ejector. A spring-box 88 and a cam 32 act through a common element, namely a bell crank 62. Either the cam or the spring-box may be removed, ejection then being provided by the other, The bell crank is mounted on the front of the press and the cam is carried by a mounting 78 enabling it to be removed from the front of the press. Accessibility is improved compared to known presses.

1. A workpiece ejector for a press comprising an ejector member for displacing a workpiece out of a die, the ejector being resiliently-biased via a pivoting lever to effect said displacement, and a mounting supporting the lever and for attachment to a front face of the platen of the press or to other accessible structure (as herein defined) of the press.

2. An ejector as claimed in claim I comprising a cam drive for effecting said displacement, the resilient-biasing and the cam drive acting on the ejector member via the pivoted lever.

3. A workpiece ejector for a press comprising an ejector member for displacing a workpiece out of a die, the ejector member being resiliently-biased to effect the ejection, and further driveable from a cam of the press to effect said ejection, the resilient-biasing and the cam drive acting on the ejector member via a common element.

4. An ejector as claimed in claim 3 wherein the common element acts as a cam follower.

5. An ejector as claimed in claim 3 wherein the common element is a pivoting lever.

6. An ejector as claimed in claim 2 wherein the pivoting lever acts also as a cam follower.

7. An ejector as claimed in claim 3 wherein the pivoting lever acts also as a cam follower.

8. An ejector as claimed in claim I wherein the pivoting lever is a bell-crank.

9. An ejector as claimed in claim 5 wherein the pivoting lever is a bell-crank.

10. An ejector as claimed in claim 2 wherein the resilient biasing and/or the cam drive is/are capable of being selectively disabled.

11. An ejector as claimed in claim 3 wherein the resilient biasing and/or the cam drive is/are capable of being selectively disabled.

12. An ejector as claimed in claim 8 wherein the resilient biasing is provided by a removable cartridge including a spring and structure for transmitting an actuating force therefrom, the resilient-biasing being disabled by removal of the cartridge.

13. An ejector as claimed in claim 8 wherein the cam drive includes a cam mountable and demountable radially of a driving shaft of the press, demounting of the cam disabling the cam drive.

14. An ejector as claimed in claim 12 wherein the shaft comprises a flange to which the cam is configured to be releasably attached.

15. An ejector as claimed in claim 14 wherein the flange has an aperture into which a securing element for securing the cam to the flange enters during said radial movement of the cam.

16. A press comprising a workpiece ejector as claimed in claim 1.

17. A press comprising a workpiece ejector as claimed in claim 3.

18. A press comprising a cam shaft, a cam carrier secured to the shaft, and a cam comprising an aperture permitting it to be placed on or removed from the shaft by movement radially thereof, the cam being removeably secured to the cam carrier.

19. A press as claimed in claim 18 wherein the cam carrier has a flange, a securing element being arranged to engage the flange during said radial movement of The cam to secure the cam to the flange.

20. A press as claimed in claim 19 wherein the flange has an aperture into which the securing element enters.

21. A press as claimed in claim 18 wherein the cam is a workpiece ejector cam.
